(19) United States
(12) Patent Application Publication
(10) Pub. No.: US 2002/0154470 A1
(43) Pub. Date: Oct. 24, 2002

(54) Energy conversion capacitors

(76) Inventor: Kevin Michael Walsh, Atlanta, GA (US)

Correspondence Address: Kevin Walsh, 1758 McLendon Ave, N.E., Atlanta, GA, 30307, US

(21) Appl. No.: 10/095,501

(22) Filed: Mar. 12, 2002

Related U.S. Application Data
(60) Provisional application No. 60/284,636, filed on Apr. 18, 2001.
(60) Provisional application No. 60/284,686, filed on Apr. 18, 2001.

(51) Int. Cl. H01G 9/00

(52) U.S. Cl. 361/523

(57) ABSTRACT

The invention uses a pair of energized capacitors connected in series, and at least one active electrode in the capacitors is capable of exchanging energy with the surroundings. The energy exchange results in a change in electron chemical potential at that electrode, and a charge exchange between capacitors may then take place until potential equilibrium is achieved. Electrical energy is generated when this charge exchange occurs, or alternately an input of electrical energy may be used to effect an absorption or release external energy. A periodic alteration of the potential of the active electrode permits a cyclical transport of charge between the capacitors. The external energy sources include thermal, chemical and photonic energy.

### CROSS-REFERENCE TO RELATED APPLICATIONS

The application claims priority to U.S. Provisional Application Ser. No. 60/284686, entitled “Thermal to Electric Energy Converter,” filed on Apr. 18, 2001, and U.S. Provisional Application Ser. No. 60/284636, entitled “Electrically-Driven Surface Absorption Heat Pump,” filed on Apr. 18, 2001.

### BACKGROUND OF THE INVENTION

This invention relates in general to energy conversion devices, and more particularly, to a capacitor pair configured to efficiently convert energy forms. The energy conversions include chemical, thermal and light to electric energy and electric to thermal energy.

### BRIEF SUMMARY OF THE INVENTION

The invention uses a pair of energized capacitors connected in series, and at least one active electrode in the capacitors is capable of exchanging energy with the surroundings. The energy exchange results in a change in electron chemical potential at that electrode, and a charge exchange between capacitors may then take place until potential equilibrium is achieved. Electrical energy is generated when this charge exchange occurs, or alternately an input of electrical energy may be used to effect an absorption or release external energy. A periodic alteration of the potential of the active electrode permits a cyclical transport of charge between the capacitors. The external energy sources include thermal, chemical and photonic energy.

### BRIEF DESCRIPTION OF THE DRAWINGS

FIG. 1 is a schematic representation of an energy conversion scheme using a capacitor.

FIG. 2 is a schematic representation of an energy conversion scheme using a pair of capacitors.

FIG. 3 is a schematic representation of a pair of charge biased capacitors.

FIG. 4 is a schematic representation of a method of charge biasing a pair of electrolytic capacitors.

FIG. 5 is a schematic representation of an energy conversion scheme illustrating the charge transfer characteristics of a charge biased capacitor pair.

FIG. 6 is a schematic representation of a generator for chemical to electric energy conversion using a pair of capacitors.

FIG. 7 is a schematic representation of a capacitor with metal-metal hydride electrodes for energy conversion from thermal to electric energy in a generator and electric to thermal energy in a heat pump.

FIG. 8 is a schematic representation of a generator for thermal to electric energy conversion using a pair of capacitors with metal-metal hydride electrodes.

FIG. 9 is a schematic representation of a heat pump for thermal to electric energy conversion using a pair of capacitors with metal-metal hydride electrodes.

FIG. 10 is a schematic representation of a capacitor with semiconductor electrodes for energy conversion from thermal to electric energy in a generator and electric to thermal energy in a heat pump.

FIG. 11 is a schematic representation of a generator for thermal to electric energy conversion using a pair of capacitors with semiconductor electrodes.

FIG. 12 is a schematic representation of a heat pump for thermal to electric energy conversion using a pair of capacitors with semiconductor electrodes.

FIG. 13 is a schematic representation of a generator for photonic to electric energy conversion using a pair of capacitors.

### DETAILED DESCRIPTION OF THE INVENTION

A capacitor basically consists of two conductive electrodes separated by an insulating interface. The electrodes may conduct current via ionic, electronic or mixed ion-electronic charge carriers. Ordinary configurations include the parallel plate and electrolytic capacitors. A parallel plate capacitor includes two closely spaced electrodes separated by a dielectric material. An electrolytic capacitor includes an electrode immersed in an ionically-conductive liquid or solid, and a dielectric material is often disposed between. A capacitor is capable of storing electric energy in the form of oppositely charged electrodes.

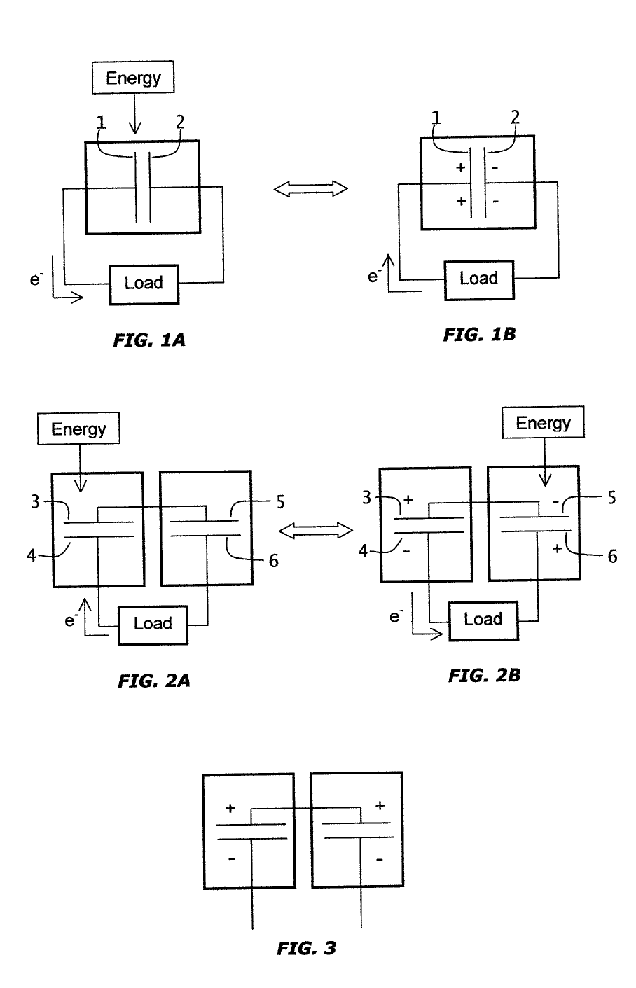

The invention includes a capacitor having at least one active electrode composed of a material that can exchange energy with its surroundings and thereby alter its electron chemical potential. When there is a difference in electron chemical potential between two conductors and they are brought into electrical contact, electrons will flow between the two until their chemical potential is equal. A capacitor, as illustrated in FIG. 1, has two electrodes 1 and 2 and an electrical load placed between the electrode pair. The active electrodes may be defined here as 1. Input of energy at I results in a increase in electron potential relative to 2 and charge then flows through the load from 1 to 2 as shown in FIG. 1A. Removal of the energy input results in a reversal of charge transfer through the load until potential equilibrium is reached, FIG. 1 B. Periodic energy input at I therefore results in a conversion of the input energy into electric energy in the form of an oscillating charge transfer between the electrodes and a transfer once in both directions represents a complete cycle.

A more preferred configuration is shown in FIG. 2, where two capacitors, as defined by electrodes 3, 4, 5, and 6, are arranged in series with an electrical load placed between the pair. The active electrodes here may be defined as 3 and 5. Input of energy at 3 results in a increase in electron potential and charge then flows to 5 while a balancing charge flow occurs between electrodes 4 and 6, FIG. 2A. Subsequent energy input at 5 coincides with a reverse transfer of charge, as indicated in FIG. 2B. While only a single active electrode is required in a functional device, it is preferred that at least two active electrodes are used with two capacitors so that charge is actively pushed (or pulled) in both directions, maximizing power output. Because capacitance is a surface/interface effect, electrodes of a relatively high surface area are also preferred to further maximize power density.

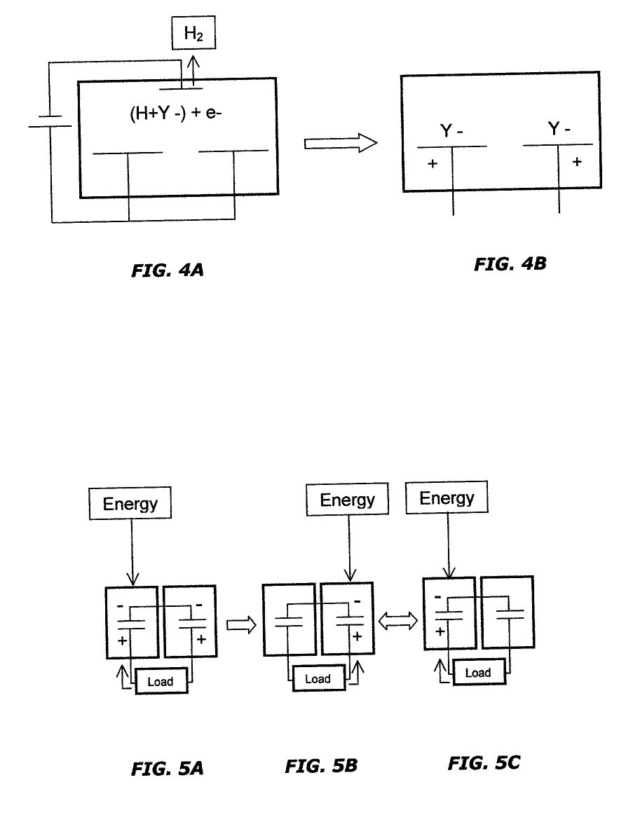

Additionally, it is most preferred to operate the capacitor pair with a static charge stored between the two, as shown in FIG. 3. This type of charge state will be referred to as charge biasing. Where the capacitors consists of a parallel plate design, the charge may be applied by temporarily connecting a battery or other power source to each capacitor using the required polarity. Where the capacitors are electrolytic, capacitor charging may be applied by any of many conventional means. A specific example is illustrated in FIG. 4, where H⁺Y⁻ may symbolize an acid electrolyte solution such as aqueous H⁺ (BF₄)⁻. A temporary electrode may be placed in the electrolyte with the positive terminal of a battery connected to the active electrodes and the negative terminal to the temporary electrode. H⁺ is removed at the temporary electrode in the form of hydrogen gas, while positive charge accumulates on the active electrodes. An opposite negative charge accumulates at the electrolyte/electrode interface.

The primary purpose of charge biasing is to reduce or eliminate a dependence of charge transfer efficiency between capacitors on the individual charge storage capability of each. In other words, in a biased state the capacitor pair contains a preexisting quantity of stored charge, and energy input simply pushes (or pulls) the charge between the capacitors. Charge biasing is stable in the absence of a significant current leakage between the two electrodes of a capacitor, however it is likely that a given system may require periodic recharging, as some small current leakage is generally expected.

The charge transfer characteristics of a biased system is illustrated in FIG. 5. An initial state where both capacitors store equal charge is shown in FIG. 5A. The initial charge transfer produced by energy input is followed by a repeating cycle in which the total stored charge is transferred between capacitors in an oscillating manner, as shown in FIGS. 5B an 5C. It is also possible that the quantity of charge stored in the capacitors may be greater or less than the quantity of charge transferred between capacitors. The former circumstance would result in a residual charge remaining, while the latter would result in a reversal of electrode polarity at one capacitor upon completion of a half cycle. The former situation of excess stored charge is the one generally preferred.

A description of specific types active electrodes that may be used to absorb or release energy, their incorporation into a capacitor structure and method of use follows.

A. Chemical to Electric Energy Conversion

Two capacitors may be constructed as a pair of palladium electrodes, separated by and immersed in a conventional liquid electrolyte, a design analogous to that of an electrolytic capacitor. The system consists of two capacitors, because charge may be stored at each electrode-electrolyte interface. The palladium electrodes may be formed by deposition of either a thin surface film preferably less than 20 nm thick, or of very small nanometer-sized particulates, on a high surface area conductor such as activated carbon felt. The palladium may be deposited by any of the known deposition techniques, including electrochemical and electroless liquid phase deposition, and physical and chemical vapor phase deposition.

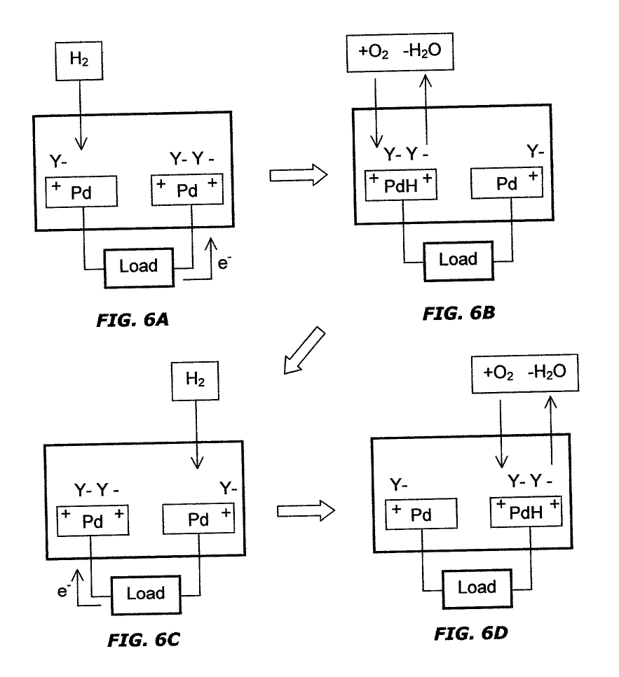

Palladium will spontaneously react with hydrogen gas to form PdH under known conditions of temperature and hydrogen pressure. The electron chemical potential of palladium increases in energy upon conversion to the hydride, due to the presence of additional electrons from the hydrogen. As shown in FIG. 6A, as hydrogen reacts with the palladium in the first capacitor to form palladium hydride, charge transfer occurs between the two capacitors. Hydrogen is then eliminated from the first electrode by reaction with oxygen to reform palladium, FIG. 6B. Subsequently hydrogen reaction with palladium in the second capacitor results in an opposite transfer of charge between capacitors, FIG. 6C. Finally, hydrogen is eliminated from the second capacitor by reaction with oxygen, FIG. 6D, and the cycle thereby returns to the original state, FIG. 6A. Repetition of the cycle results in a continuous conversion of chemical to electric energy.

As indicated in FIG. 6, the preferred arrangement is a positive charge bias located on the palladium electrodes relative to the electrolyte. The preferable magnitude of charge biasing is at least sufficient such that a small positive bias relative to the electrolyte is maintained on the electrode at which PdH formation is taking place. Restated, the total quantity of stored charge is slightly greater than the quantity transferred. The rate of charge transfer should not exceed the reaction rate of hydrogen. In addition to the previously disclosed function biasing provides, here it also functions to help restrict PdH formation to the palladium atoms at the metal surface, for it is only the surface Pd atoms that influence the capacitive charge on the electrode. The reason for this is that electric fields have only very shallow penetration depths into metallic conductors, on the order of angstroms. Formation of PdH below the electric field results in a reduction of energy conversion efficiency.

It is also preferred that the hydrogen be eliminated from PdH via reaction with oxygen until an approximate stoichiometry of PdH_{0.24} is reached. In general, no further change in electron chemical potential would be expected to occur at Pd/H ratios lower than 1/0.24. However, the optimum ratio for a given system may vary and an optimum value may be determined by measurement of conversion efficiency versus Pd/H ratio. A hydrogen partial pressure of at least one atmosphere is also preferred.

Metals, alloys and compounds other than palladium may be used that are known to reversibly absorb and/or adsorb hydrogen, as well as other reactive gases. Hydrogen is the preferred reactant due to its usually high reaction rates. The sole requirements of the electrode material and the associated reactants is that the reaction result in a change in the electrode electron chemical potential and that the reaction product be electrically conductive, or at least semiconductive (less than 10¹⁰ ohm-cm).

Additional examples of materials that absorb hydrogen with a resulting change in electron chemical potential include niobium, vanadium, rare earth nickel alloys, alkaline earth nickel alloys, activated carbon, vanadium(V) oxide, tungsten trioxide and molybdenum trioxide. Another gaseous reactant example is oxygen, which is known to react with many metals to form a range of conducting and semiconducting oxides and suboxides. The oxygen may be partially or completely removed in a cycle by reaction with a reducing agent such as hydrogen.

B. Thermal to Electric Energy Conversion

Metal-Metal Hydride Active Electrodes

The palladium-hydrogen reaction is known to be thermally reversible, and in an alternate embodiment the hydrogen is removed from the PdH electrode by heating. The electrode-electrolyte configuration is less preferred where thermal energy is used, in favor of a parallel plate configuration. FIG. 7 illustrates the preferred structure of a thermal palladium-hydrogen capacitor. The layers in the figure are not shown to scale. A first electrode consisting of an inner layer of lithium-doped nickel oxide that is less that 1 micron thick and an outer nickel layer at least 10 microns thick. A TiO₂ dielectric layer is approximately 1 micron thick. And a second electrode having an outer nickel layer is approximately 100 nm and an inner palladium film less than 10 nm. The capacitor may be fashioned by anodic oxidation of nickel in an electrolyte containing lithium salts to form the first electrode, followed by successive deposition of the dielectric, palladium and nickel layers. The electrodes are preferably of very high unit surface area and the starting nickel substrate is preferably fabricated as a high surface area sheet by conventional techniques such as etching prior to deposition of the dielectric and active electrode layers.

The nickel/lithium-nickel oxide electrode functions to transport and store electronic charge, while the TiO₂ dielectric provides electrical insulation and enhances charge storage capabilities. The palladium reversibly reacts with hydrogen and stores electronic charge. The nickel layer over the palladium supports electrical conductivity and provides a permeable pathway for hydrogen transport. A nickel grid may optionally be placed over the thin nickel layer to further facilitate transport of electronic charge.

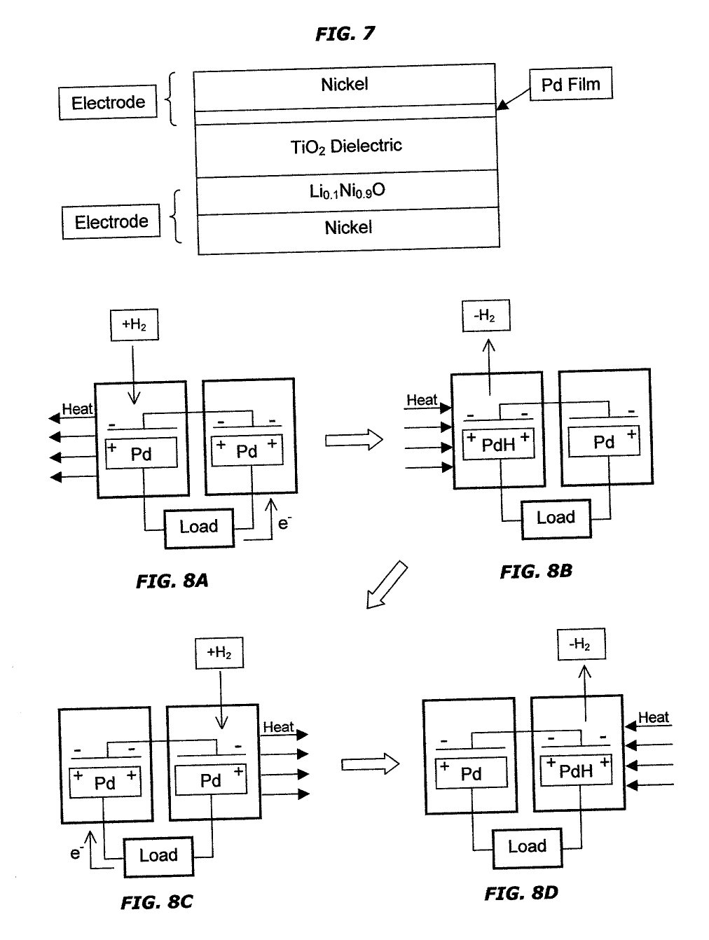

The preferred configuration utilizes two of the capacitors of the type shown in FIG. 7, and the palladium electrodes cycle between PdH and PdH_{0.24} by alternate absorption and release of hydrogen gas. Electrical power is extracted in a continuous cycle as shown in FIG. 8, and in this instance an electronic countercharge flows between the nickel oxide electrodes. As shown in FIG. 8A, as hydrogen reacts with the palladium in the first capacitor to form palladium hydride, charge transfer occurs between the two capacitors. Hydrogen is then eliminated from the first electrode by heating to reform palladium, FIG. 8B. Subsequently hydrogen reaction with palladium in the second capacitor results in an opposite transfer of charge between capacitors, FIG. 8C. Finally, hydrogen is eliminated from the second capacitor by reaction with oxygen, FIG. 8D, and the cycle thereby returns to the original state, FIG. 8A. Repetition of the cycle results in a continuous conversion of chemical to electric energy.

As indicated in FIG. 8, the preferred arrangement is for both Pd electrodes hold a positive charge bias relative to the nickel oxide electrodes. It is also preferred that electrical power discharge and hydrogen absorption occur simultaneously, so that while the palladium electrode is reacting with hydrogen there is always maintained at least a small positive charge on that electrode. A hydrogen partial pressure of at least one atmosphere is preferred. The substitutions for palladium cited in the previous embodiment are also applicable here. Substitutions for the nickel, titanium dioxide and nickel oxide may also be made with materials that are known to possess similar or equivalent properties and thereby execute the identical functions.

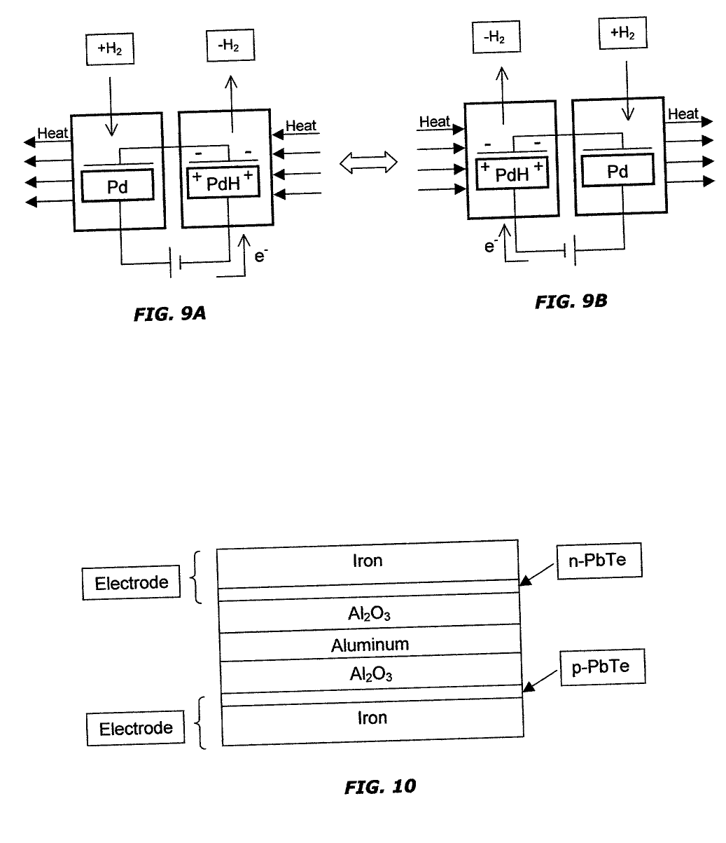

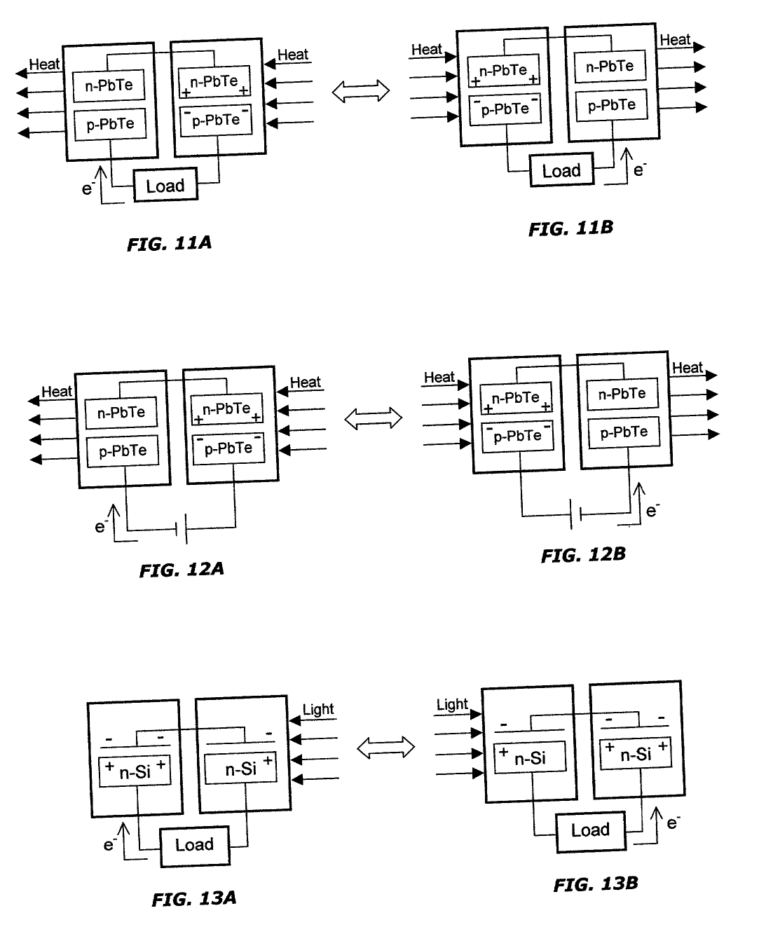

Two capacitors identical to that shown in FIG. 7 may also be used to transport heat against a thermal gradient by input of electrical energy. This embodiment is illustrated in FIG. 9. A hydrogen partial pressure of less than one atmosphere is preferred in a room temperature heat pump mode. Metal hydrides whose decomposition temperature is too low for use in thermal to electric conversion are suitable for heat pumping, including nickel.

Semiconductor and Semimetal Active Electrodes

Many semiconductors and semimetals exchange electronic charge when placed in contact with other semiconductors and semimetals, and the degree of the charge transfer is temperature dependant. Conventional thermoelectric devices utilize this effect to generate electric power by providing two junctions between dissimilar semiconducting materials and maintaining a temperature differential between the junctions. Typically small band gap semiconductors of less than 1.5 eV are used and an n-type semiconductor is paired with a p-type. Although metals may be used as well, they tend to display relatively little change in electron potential with temperature and are therefore less suited than semiconductors. The terms n-type and p-type refer to the predominant charge carrier type. In n-type semiconductors the charge carriers are negatively charged mobile electrons, while in p-type semiconductors the charge carriers are positively charged mobile holes. The n-type PbTe/p-type PbTe semiconductor pair is a well known example. For example, in the PbTe system, n-doping may be accomplished by adding PbCl₂ and p-doping with Na₂Te. The chloride adds one more electron than tellurium, while sodium adds on less electron than lead.

A capacitor may be prepared by deposition of n-PbTe layer of less than 10 microns onto a thin iron sheet, and a p-PbTe layer may be similarly deposited onto a second thin iron sheet. The two layered sheets are then placed together with the doped PbTe layers adjacent and a thin dielectric film placed between. The dielectric may be silica glass. The dielectric is preferably less than 300 microns thick.

A more preferred capacitor with the structure shown in FIG. 10 may be used in a thermal to electric energy conversion. The layers in the figure are not shown to scale. One electrode is n-type PbTe while the other electrode is p-type PbTe, and both are preferably less than 1 micron thick. The PbTe layers are deposited on opposite sides of an etched, surface oxidized aluminum sheet, which serves as a high surface area dielectric barrier. The aluminum may be made at a minimum thickness needed to provide for this function. An iron layer is then deposited over both PbTe layers at a thickness preferably less than 20 microns to provide for a non-reactive electrical contact. Two of the capacitors of the kind shown in FIG. 10 are used in the thermal energy converter. Electrical power is extracted in a continuous cycle as shown in FIG. 12. As indicated, the ptype PbTe electrodes are preferably negatively biased relative to the n-type PbTe electrodes, and it is generally the case that preferably a p-type electrode is negative, while an n-type positive.

In this embodiment all four of the electrodes in the capacitor pair are active, those containing the p-type semiconductor increase in electron chemical potential with heating, while the n-type semiconductor electrodes decrease in potential. The thermoelectric conversion process described here may be contrasted with conventional Seebeck thermoelectric devices where an induced temperature gradient across two dissimilar junctions is used to produce the energy conversion. The temperature gradient results in heat losses via thermal transport along the gradient. The present invention, however, requires neither direct thermal contact between the capacitor pairs, nor a temperature gradient within a capacitor.

Other known thermoelectric pairs may be used and include n-type FeSi₂ with p-type higher manganese silicide (MnSi_{1.7-1.75}), Bi₂(TeSe)₃/(BiSb)₂Te₃, Na_{0.01}Mn_{0.99}Te/MnTe, n-type Ge/p-type Ge, and n-type PbSe/p-type PbSe. The material's band gap is conventionally chosen to be larger when relatively higher temperatures are used. Substitutions for the other materials explicitly described may also be made with materials that are known to possess similar or equivalent properties and thereby accomplish the same functions.

Regarding a preference between the metal hydride and semiconductor thermal-electric conversion embodiments, the metal hydride device is preferred where maximum power density and efficiency is required for a given temperature range, while the semiconductor device is preferred where the lack of hydrogen transport is advantageous.

Two capacitors identical to that shown in FIG. 10 may also be used to transport heat against a thermal gradient by input of electrical energy, referred to as heat pumping. This embodiment is illustrated in FIG. 12.

C. Photonic to Electric Energy Conversion (Photovoltaic)

Light energy may be converted to electric energy through the use of a semiconductor such as silicon as the active electrode. The electron chemical potential of the electrode is altered by absorption of light with resultant generation of a charge carrier pair. The charge carriers are separated by an electric field at the electrode-dielectric interface. Silicon is the preferred electrode material and silicon may be acceptor or donor-doped to produce p- and n-type silicon in a manner identical to the discussion of lead telluride. Boron and phosphorus are the usual dopants used to prepare p- and n-type silicon, respectively.

A capacitor may be constructed by first depositing a transparent, porous indium-tin oxide (ITO) film over a glass substrate by a powder spray or sol gel method. Amorphous n-type silicon is then vapor deposited over the ITO. The electrode is heated in air to form a thin SiO₂ dielectric layer over the surface of the silicon. The thickness of the silicon layer remaining after oxidation is chosen to provide for absorption of the majority of incident light, this thickness being dependant upon the porosity and depth of the ITO-silicon electrode. And finally, two such panels are placed together with the silicon layers adjacent. The porous interior is then filled with a conventional electrolyte to form a complete capacitor pair. The silicon electrodes are then positively charge biased relative to the electrolyte counter electrodes.

Energy conversion occurs when a first capacitor is illuminated and while a second capacitor is dark, and charge transfer occurs simultaneous to illumination. The cycle is illustrated in FIG. 13. The electrolyte in FIG. 13 is symbolized as a pair of electrically connected, charged plates. The cycle may be realized by mechanical rotation of the flat plate, so that each side of the plate is alternately exposed to incoming light.

As indicated in the figure, it is preferred that there is an excess quantity of stored charge relative to the charge transferred between capacitors, so that there is a residual positive bias on the darkened electrode at completion of a half cycle. The capacitive charge and its associated electric field at the silicon-dielectric interface contribute to an effective separation of the photogenerated charge carriers. The preferred residual charge remaining on the darkened electrodes is dependant upon a particular system and the total charge it stores. The strength of the residual electric field at the darkened Si/SiO₂ interface is preferably sufficient to maintain a depletion of mobile charge carriers from this region. Optimum values may be readily obtained by conversion efficiency measurements for a particular system.

Another, more preferred configuration for reduced manufacturing costs is as follows. A p-type crystalline silicon powder is lightly compressed and annealed to form a solid, porous structure. The porous silicon is then etched to further increase the surface area by liquid phase chemical or electrochemical etching in a fluoride containing bath or other known methods. Plates approximately 1 mm thick are sliced from the bulk porous silicon and an aluminum grid is bonded to one side. The porous plate is then oxidized to create insulating Al₂O₃ and SiO₂ surfaces by methods including electrochemical oxidation or heating in air. The aluminum grid may optionally be coated with a protective organic coating. The silicon pores are then impregnated with a film of transparent conductive material such as ITO by known deposition methods. Two plates are placed together with the aluminum grids adjacent and a graphite felt layer between to facilitate electronic conduction between ITO electrodes on each side. Finally, glass covers are provided and the structure is sealed. External power is delivered via the aluminum grids, which may be extended outside the cell seal.

A p-type silicon is preferred in this embodiment to facilitate charge transport across the silicon-aluminum junctions. Because a p-type semiconductor is used, the silicon electrodes are preferably negatively charge-biased relative to the ITO electrodes and the charge bias should be of sufficient magnitude that at least some residual negative charge remains on the darkened active electrode upon completion of a half cycle, as previously discussed.

Other materials know to be useful in photovoltaic conversion may be used in the cells described. Semiconductors typically used for solar energy conversion have band gaps ranging from 0.75 eV to 2.25 eV. These materials include organic semiconductors, copper indium diselenide, gallium arsenide, and cadmium telluride. Substitutions for the other materials explicitly described may also be made with materials that are known to possess similar or equivalent properties and thereby accomplish the same functions.

### SUMMARY AND SCOPE OF THE INVENTION

Charge exchange between capacitors is shown to occur between single pairs only. However, it is also possible when more than two capacitors are used that charge may be exchanged between different capacitors at different points in the cycle. The charge exchange may be partial so that the total exchange occurs between multiple capacitors. As an illustrative example, the thermally-driven capacitors of FIGS. 7&10 may be constructed as multiple adjacent capacitors arranged in the form of a rotating disk placed between a hot and cold sink. Two adjacent disks are made to rotate in opposite directions, with stationary electrical contacts placed between. Such an arrangement may be used to achieve a counter-current transfer of charge between capacitors.

The capacitors cells may be stacked with a collector grid placed against the electrodes for external delivery of charge, and with an insulating layer placed between adjacent grids to electrically isolate a capacitor cell. The charge transfer between capacitors may also occur in series to increase voltage across a load or in parallel to increase amperage. Numerous additional arrangement are also feasible.

It is to be realized that only the preferred embodiments of the invention have been described and that numerous substitutions, alterations and modifications are permissible without departing from the spirit and scope of the invention as defined in the following claims.

I claim:

1. An apparatus for energy conversion comprising:
(a) an energy exchange means for exchange of external energy with a first capacitor electrode to create a periodic alteration of the electrode's electron chemical potential and
(b) a conductive means for transport of an oscillating electric charge between the first capacitor electrode and a second capacitor electrode in reaction to the periodic alteration of electron chemical potential.

2. The apparatus of claim 1, wherein the apparatus is a generator of electricity.

3. The apparatus of claim 1, wherein the apparatus is a heat pump.

4. The apparatus of claim 1, further including least two capacitors connected in series.

5. The apparatus of claim 4, further including a stored electric charge on the capacitor pair.

6. The apparatus of claim 5, wherein the apparatus is a generator of electricity.

7. The apparatus of claim 6, wherein the apparatus is a photovoltaic generator of electricity.

8. The apparatus of claim 7, wherein the energy exchange means further comprises a semiconductor.

9. The apparatus of claim 8, wherein the semiconductor has a band gap between 0.75 and 2.25 eV.

10. The apparatus of claim 6, wherein the apparatus is a thermoelectric generator of electricity.

11. The apparatus of claim 10, wherein the energy exchange means further comprises a semiconductor.

12. The apparatus of claim 10, wherein at least one electrode is a p-type semiconductor and at least one electrode is an n-type semiconductor.

13. The apparatus of claim 6, wherein the energy exchange means further comprises a reversible metal hydride.

14. The apparatus of claim 5, wherein the apparatus is a thermoelectric heat pump.

15. The apparatus of claim 14, wherein at least one electrode is a p-type semiconductor and at least one electrode is an n-type semiconductor.

16. The apparatus of claim 14, wherein the energy exchange means further comprises a reversible metal hydride.

17. The apparatus of claim 6, wherein the apparatus is a converter of chemical energy to electricity.

18. The apparatus of claim 17, wherein the chemical energy comprises a reaction between hydrogen and oxygen.

19. A method for energy conversion comprising:
(a) periodically altering the electron chemical potential of a first capacitor electrode by exchange of external energy, and
(b) transporting an oscillating current between said first capacitor electrode and a second capacitor electrode in response to the altering electron chemical potential.

20. The method of claim 19, wherein the energy conversion generates electric energy.

21. The method of claim 19, wherein the energy conversion generates a transport of thermal energy.

22. The method of claim 19, wherein said oscillating charge transport is between a pair of capacitors connected in series.

23. The method of claim 22, further including storing an electric charge between the two capacitors.

24. The method of claim 23, wherein the energy conversion is photonic to electric energy.

25. The method of claim 23, wherein the energy conversion is thermal to electric energy.

26. The method of claim 23, wherein the energy conversion is electric to thermal energy.

27. The method of claim 23, wherein the energy conversion is chemical to electric energy.
